(19) United States
(12) Patent Application Publication
(10) Pub. No.: US 2020/0064986 A1
(43) Pub. Date: Feb. 27, 2020

(54) VOICE-ENABLED MOOD IMPROVEMENT SYSTEM FOR SENIORS

(71) Applicant: Caressa Corporation, San Mateo, CA (US)

(72) Inventor: John Huang, San Mateo, CA (US)

(21) Appl. No.: 16/548,724

(22) Filed: Aug. 22, 2019

Related U.S. Application Data
(60) Provisional application No. 62/721,176, filed on Aug. 22, 2018.

(51) Int. Cl. G06F 3/0484; G06F 9/451; G06F 16/23; G06Q 50/00; G06Q 30/06; G06N 5/04; G06F 3/16

(52) U.S. Cl. CPC G06F 3/04842; G06F 9/451; G06F 16/2379; G06F 3/167; G06Q 30/0641; G06N 5/04; G06Q 50/01

(57) ABSTRACT

A method includes receiving a plurality of data items pertaining to a user. A mood of the user is automatically assessed using the plurality of data items, whereafter it is determined that the assessed mood of the user corresponds to a determinable state. Responsive to the determination, a graphical user interface presents a user-selectable indicium to a member of a social network of the user, the user-selectable indicium being selectable by the member of the social network to initiate a request to modify the mood of the user. Responsive to user selection of the user-selectable indicium, the request to modify the mood of the user is received at a communications server, which automatically initiates a mood improvement response.

### CROSS-REFERENCE TO RELATED APPLICATIONS

This application claims the benefit of U.S. Provisional Application No. 62/721,176, filed Aug. 22, 2018, entitled “VOICE-ENABLED MOOD IMPROVEMENT SYSTEM FOR SENIORS,” which is incorporated herein by reference in its entirety.

### BACKGROUND

By the year 2030, one-fifth of the population will be seniors, and seventy percent of these seniors will live alone. With this market size, and an additional 10,000 people reaching the age of 65 every day, there is a need to connect family socially and manage the physical and emotional well-being of the senior living apart.

Many of us have elderlies or seniors in our family: our parents, grandparents, and even old uncles or aunts. There is a need for connection and communication with these seniors, but the busyness of life for younger generations often restricts such communication. Additionally, technology adoption is difficult among seniors. Furthermore, seniors want to be treated like regular human-beings with dignity.

Current solutions that seek to address the above challenges include various communication products such as emergency pendulums and psychologically rejected three-button senior phones. Recent developments in voice user interfaces have rendered these more senior-friendly and increased adoption with a lower learning curve.

### BRIEF DESCRIPTION OF THE SEVERAL VIEWS OF THE DRAWINGS

To easily identify the discussion of any element or act, the most significant digit or digits in a reference number refer to the figure number in which that element is first introduced.

FIG. 1 is a diagrammatic representation of a networked environment in which the present disclosure may be deployed, in accordance with some example embodiments.

FIG. 2 illustrates a process flow 200, according to some example embodiments.

FIG. 3 illustrates a system architecture 300, according to some example embodiments.

FIG. 4 illustrates a dashboard tab or interface 400, according to some example embodiments.

FIG. 5 illustrates a newsfeed tab or interface 500, according to some example embodiments.

FIG. 6 illustrates an interface, according to some example embodiments.

FIG. 7 illustrates an interface, according to some example embodiments.

FIG. 8 illustrates a perturbation flow 800, according to some example embodiments.

FIG. 9 illustrates an emotion matrix 900, according to some example embodiments.

FIG. 10 illustrates training and use of a machine-learning program, according to some example embodiments.

FIG. 11 is a diagrammatic representation of a processing environment, according to some example embodiments.

FIG. 12 is a flowchart illustrating a method to automatically adjust the mood of a senior user, according to some example embodiments.

FIG. 13 is a block diagram showing a software architecture within which the present disclosure may be implemented, according to some example embodiments.

FIG. 14 is a diagrammatic representation of a machine in the form of a computer system within which a set of instructions may be executed for causing the machine to perform any one or more of the methodologies discussed herein, according to some example embodiments.

### DETAILED DESCRIPTION

### Glossary

“Carrier Signal” in this context refers to any intangible medium that can store, encoding, or carrying instructions for execution by the machine, and includes digital or analog communications signals or other intangible media to facilitate communication of such instructions. Instructions may be transmitted or received over a network using a transmission medium via a network interface device.

“Component” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine 1000) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may, then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine; but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Machine-Storage Medium” in this context refers to a single or multiple storage devices and/or media (e.g., a centralized or distributed database, and/or associated caches and servers) that store executable instructions, routines and/or data. The term shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Processor” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU); a Reduced Instruction Set Computing (RISC) processor, a Complex Instruction Set Computing (CNC) processor, a Graphics Processing Unit (GPU), a Digital Signal Processor (DSP), an Application Specific Integrated Circuit (ASIC), a Radio-Frequency integrated Circuit (RFIC) or any combination thereof. A processor may further be a multi-core processor having two or more independent processors (sometimes referred to as “cores”) that may execute instructions contemporaneously.

“Communication Network” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (CPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Computer-Readable Medium” in this context refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably, in this disclosure.

“Signal Medium” in this context refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

### Description

The example embodiments described herein seek to address the seniors' needs for connection and communication based on their and their families' preferences. One example embodiment relates to a voice-enabled communication system to connect seniors living independently to their family, friends, and the world. The communication system includes a social media platform with voice extensions/interfaces for seniors and an application (e.g., a mobile application) for family and friends. Upon activation, a voice engine leads a natural conversation that includes family updates, checks on health and emotional well-being, and conversation topics of daily life with the seniors. These interactions are processed and distributed to their family and friends by the mobile application in order to ignite, enhance and strengthen further social connections. Using the mobile application, the family can interact with each other (e.g., in a newsfeed tab or interface), and monitor the well-being of the seniors (e.g., in dashboard tab or interface).

Besides monitoring the medical and physical status, the example communication system tracks the emotional well-being of the seniors (e.g., the results of which may be displayed in a dashboard tab of the mobile application). A family member may, for example, with a click of the IMPROVE mood button on the mobile application, invoke automated functionality that seeks to improve the mood of the seniors. Since the communication system has stored, processed and generated data indicative of what makes that individual senior smile and more through prior interactions, this feature is highly personalized in order to enable conversations and other interactions for each individual senior to achieve a desired mood. An example is when the granddaughter's iPhone notifies her that grandmother is slightly depressed, she can click an IMPROVE mood button on her iPhone to make her grandmother happier. The voice engine will alter the content of its conversation (or other interactions) in an attempt to achieve the desired state of emotional well-being (e.g., mood improvement).

Example embodiments relate to methods and systems for tracking the mood of a person for the purpose of subsequent mood adjustment. The example embodiments achieve mood tracking by measuring the effects and outcomes of various emotional events (e.g. perturbations) to determine a multitude of mood states. For the purposes of the current specification, the word “perturbances” may include any disturbance or change of emotional state. With machine learning, relationships between perturbation inputs and mood outputs is determined or discerned. The example embodiments seek to achieve mood adjustment by reversing such relationships and provides a clickable option to a person for the purpose of mood adjustment of the person whose emotional states are being tracked.

Example embodiments seek to make social connections possible through an AI-driven conversation engine that acts as a voice interface for seniors (e.g., through an Alexa skill) and to a family with the mobile application.

Even though voice interfaces traditionally have a lower learning curve for seniors, they do not adopt easily because they are typically command-driven (e.g., such as the Alexa voice interface developed by Amazon). Accordingly, many senior users end up using it only as a timer or alarm clock. A conversation-based product activated with only one single command is needed. Example embodiments described herein lead and guide the conversations with materials generated by (1) Family members, (2) Internet sources, and (3) Third Party Information Providers (e.g., advertisers and non-profit organizations).

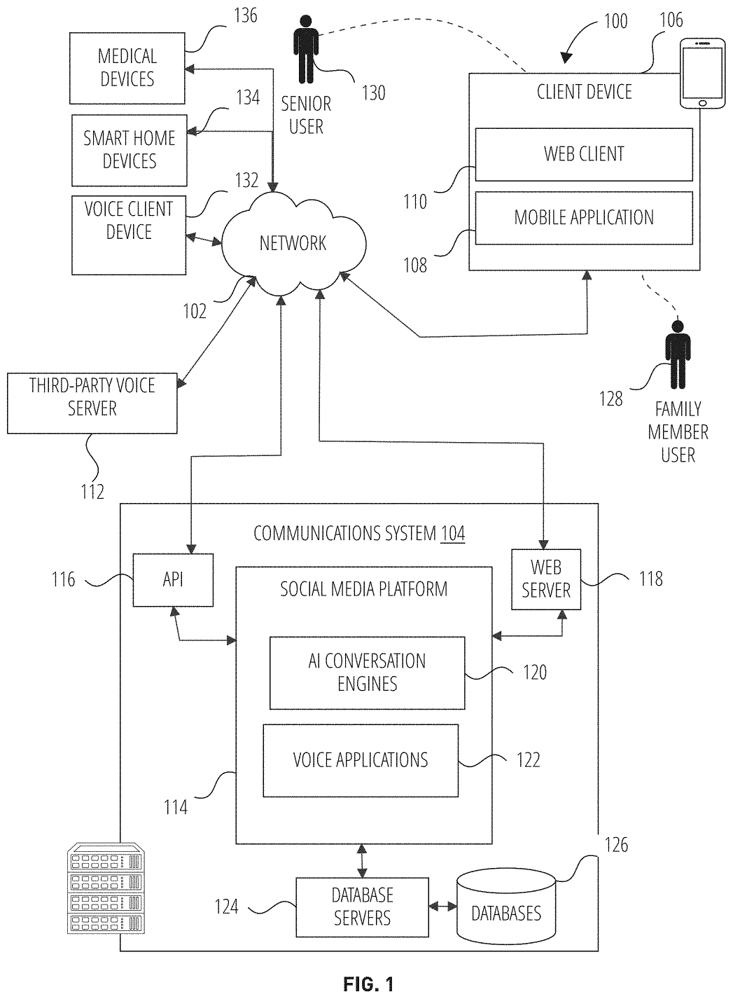

FIG. 1 is a diagrammatic representation of a network environment 100 in which some example embodiments of the present disclosure may be implemented or deployed.

A communications system 104 provides server-side functionality via a network 102 to a networked user device, in the form of a mobile client device 106 and a voice client device 132 (as an example of a voice interactive device). The voice client device 132 may be used by a senior user 130, while the client device 106 is used by a family member user 128. A web client 110 (e.g., a browser) and a mobile application 108 (e.g., an “app”) are hosted and executed on the client device 106. The mobile application 108 is dedicated to use with the communications system 104 and facilitates interactions by the family member user 128 with the senior user 130 via the communications system 104. Similarly, the voice client device 132 hosts one or more voice applications that enable the senior user 130 to interact with the communications system 104.

An Application Program Interface (API) 116 and a web server 118 provide respective programmatic and web interfaces to the communications system 104. The communications system 104 hosts a social media platform 114 that includes AI conversation engines 120 and voice applications 122, which in turn include components, modules and/or applications. Each of the voice applications 122 may support and provide a distinct “voice skill” or “voice capability.”

Both the voice client device 132 and the mobile application 108 communicate with/access the communications system 104 via the web interface supported by a web server 118 and via the programmatic interface provided by the Application Program Interface (API) 116.

The social media platform 114 is shown to be communicatively coupled to database servers 124 that facilitates access to an information storage repository or databases 126. In an example embodiment, the databases 126 includes storage devices that store information to be published and/or processed by the AI conversation engines 120.

The voice client device 132 may additionally use voice services provided by a third-party voice server 112 (e.g., Alexa by Amazon.com).

Accordingly, the example embodiments described is shown to include two user components, namely:
For seniors, the voice client device 132, which is a senior voice-enabled companion device capable of carrying on natural conversations that are always available to address everyday needs and social isolation.
For family, the mobile application 108 to provide visual insights (e.g., physical, medical, emotional states of senior) and newsfeed for interactions among family members and the seniors.

De-synchronization between these two user components permits families with busy lives that to maintain a social connection with a list busy senior. The example embodiments thus provide a new social interface taking advantage of voice platform and well suited to a rapid growing senior market.

Voice interface (e.g., Alexa or Siri) adoption rates by seniors are currently very low right, primarily because seniors have difficulty remembering too many commands or proper usage of such commands. According to example embodiments, senior only need to remember to say a single command (e.g., “Open Caressa”), where after the voice client device 132 will lead and converse with the senior by fetching family updates from each mobile application 108 and/or the databases 126. Such social feeds facilitate recurring usage of the system. In addition, the conversations include real-time information on news, weather, facts, games, and other sources. The communications system 104 feeds such information while at the same time monitoring emotion, medical, and physical well-being of the senior, using further inputs received from an array of devices, such as smart home devices 134 and medical devices 136, associated with the relevant senior.

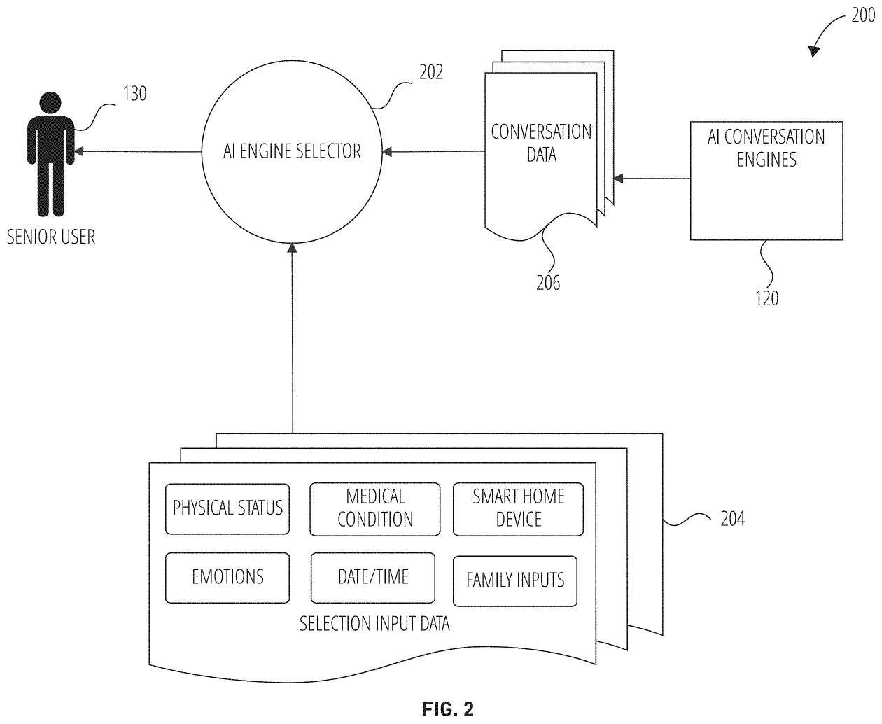

FIG. 2 illustrates a process flow 200, according to an example embodiment. As alluded to above, and according to various example embodiments, the communications system 104, which includes a social media platform 114 with voice extensions (e.g., the voice applications 122) connects seniors to friends and family by a mobile application (e.g., the mobile application 108) to. Upon activation, the voice applications 122 lead a conversation with seniors (e.g., the senior user 130). Besides daily topics of interests, the communications system 104 provides interactions with family and friends having access to the mobile application 108. Seniors initiate a conversation via the voice client device 132 with a single command (e.g., the “Open Caressa” command). The voice applications 122 then lead the conversation for seniors to respond with intuitive answers.

As shown in FIG. 2, a conversation for a communications session (e.g., voice to text session) with a senior is weaved together from conversation data 206 outputted from the AI conversation engines 120 in the example form of a pool of “micro conversational engines,” each with its own purpose. The conversation data 206 from the voice AI conversation engines 120 may include, merely for example, reporting news and weather, discussing medical topics, recalling events, playing memory games, telling a joke, and more. A conversation may also lead to recommending products and services by advertisers with their own scripted advertisements. An AI engine selector 202 intelligently picks and weaves together these micro-conversations based on selection input data 204, including senior's physical, emotional, and medical status as well as other factors, such as time, preferences, and monetization priorities with respect to advertisers (e.g., costs to have advertisements inserted or keyword analysis).

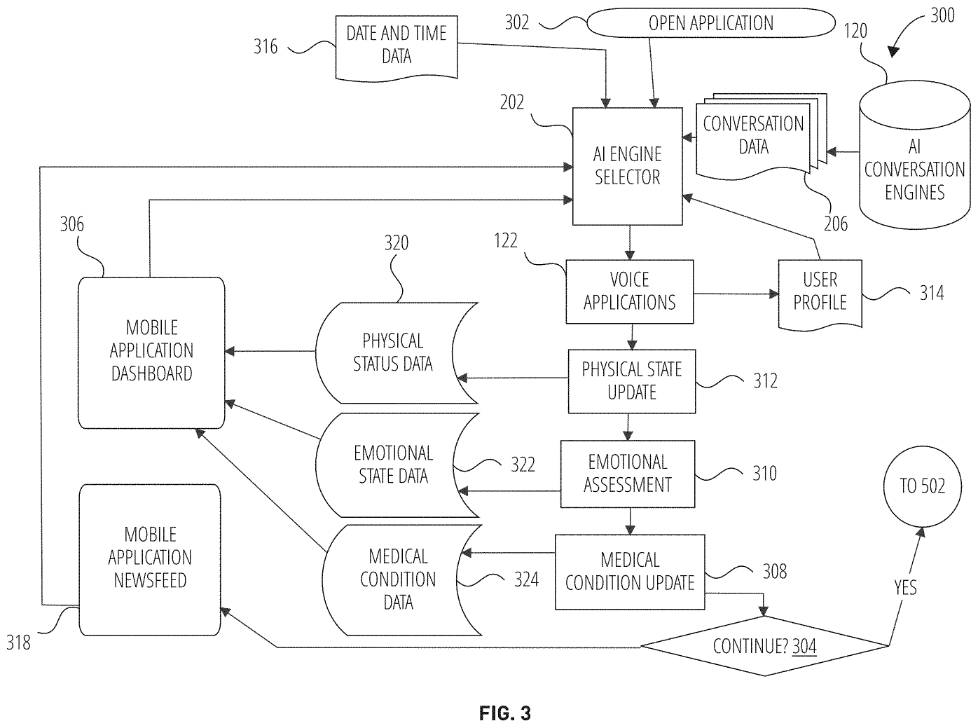

The conversations are also interlaced with updates from family and friends received via the mobile application 108, and specifically a mobile application dashboard 316 (see FIG. 3). Seniors are motivated to engage the social media platform 114 for information consumption. The interactions and reactions to these conversations by the seniors are shared to the family and friends by the mobile application 108 to engender and enhance social connections.

Besides monitoring the medical and physical status, the communication communications system 104 tracks the emotional well-being of the senior user 130, using for example the smart home devices 134, and the medical devices 136. Further functionalities include enabling family members, with the click of a button on the mobile application 108, to try to improve the mood of the senior user 130

Since the communications system 104 accesses data regarding what factors are effective to adjust the mood of a senior (e.g., makes that individual senior smile and more), the communications system 104 is able to implement personalization in order to carry out the right conversations for each individual senior to achieve the desired mood.

These interactions are pushed to the senior user 130 via a newsfeed (e.g., a mobile application dashboard 316) on the mobile application 108 to generate additional social engagements among family and friends.

Family and friends may access the mobile application 108 in order to interact with each other, and with the senior user 130 operating the voice client device 132 through a voice assistant. By de-synchronizing these interactions, relatives can maintain social connections with each other and with seniors living apart without intrusion.

By enabling such social connections on the social media platform 114, the communications system 104 provides seniors with a sense of security and emotional attachment. Seniors repeat engagements to obtain the latest information and family updates for emotional reassurance.

FIG. 3 is a schematic diagram showing an overall system architecture 300, according to an example embodiment. Building on the description provided with respect to FIG. 2, the AI conversation engines 120 provide conversation data to the AI engine selector 202, which weaves the conversation data 206 into a conversation flow that is provided by the voice applications 122, in the form of a voice response, to the senior user 130. To this end, the voice client device 132 provides a voice response to the senior user 130 based on flow outputted from the AI engine selector 202.

In addition to receiving the conversation data 206, and date and time data 314 as input, the AI engine selector 202 also receives data from a user profile 312 for the senior user, as well as inputs from a mobile application dashboard 316 and a mobile application newsfeed 318 of the mobile application 108 (as examples of an open application 302) as inputs. The AI engine selector 202 uses all of these inputs in order to provide a customized conversation flow to the voice applications 122.

The communications system 104 operationally requests a physical state update 310, initiates an emotional assessment 308, or retrieves a medical condition update 306. This information may be gathered in various ways, for example via a voice engine prompt communicated to the voice client device 132, from information retrieved from the smart home devices 134, or from data collected by medical devices 136 that are deployed within an environment of the senior user 130. The gathered physical status data 320, emotional state data 322, and medical condition data 324 are then communicated, via the communications system 104, to the mobile application 108, where it is made available via a mobile application dashboard 316.

The process illustrated in FIG. 3 may also then continue to present news and other information to both the senior user and family users via a news feed interface (e.g., a mobile application newsfeed 318 of mobile application 108). Input received from the senior user, and the family users via the mobile application dashboard 316 and the mobile application newsfeed 318, then is provided back into the AI engine selector 202 so that the voice applications 122 operationally provide appropriate voice responses to the senior user 130 via the voice client device 132.

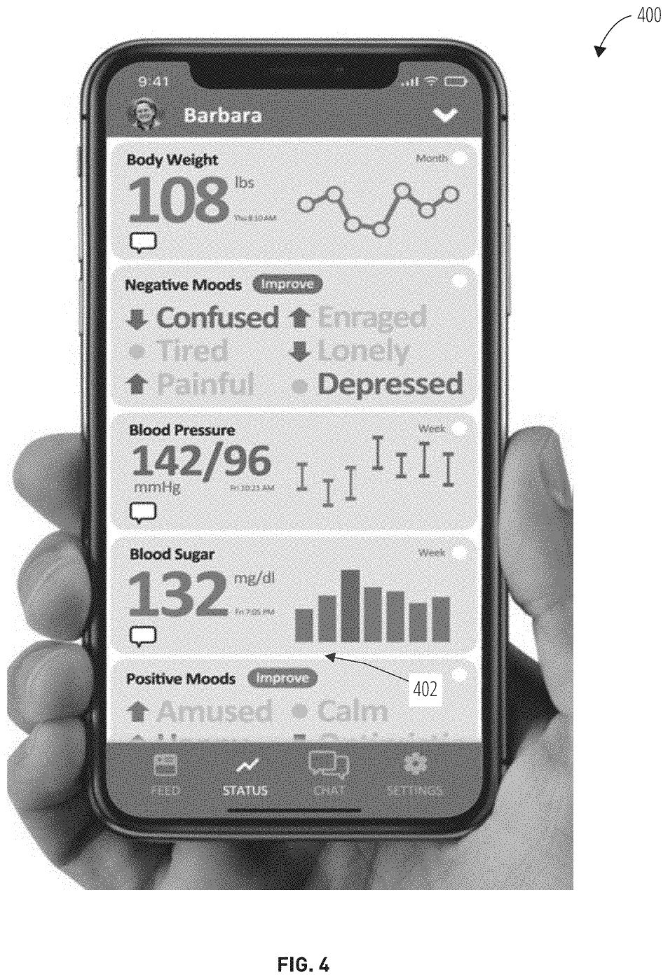

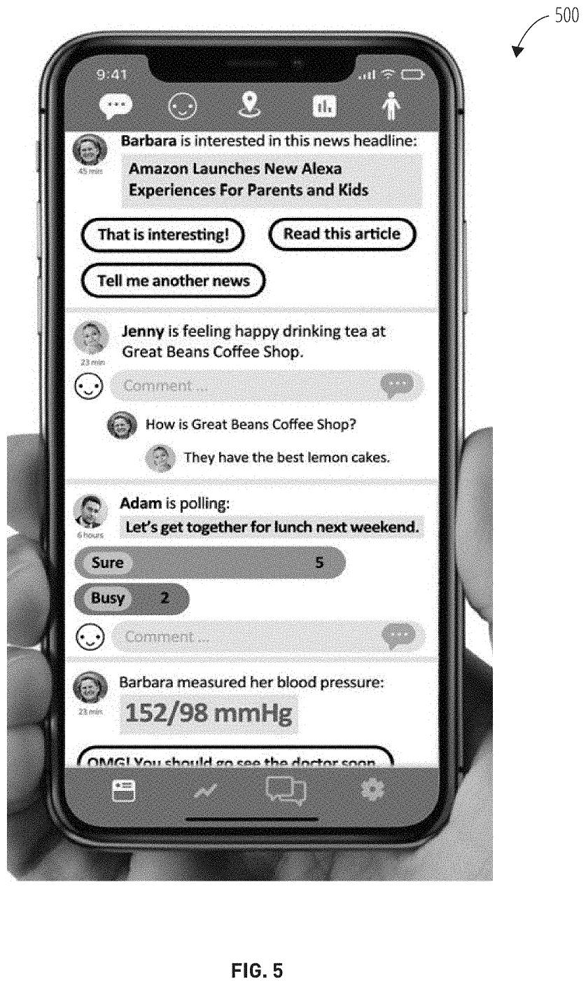

Turning now specifically to the mobile application 108, there are two main tabs (or interfaces) presented by the mobile application 108, namely the mobile application newsfeed 318 and mobile application dashboard 316. The mobile application dashboard 316 (see FIG. 4) provides a dashboard tab or interface 400 that presents the latest interactions between family members. The mobile application newsfeed 318 (see FIG. 5) provides a newsfeed tab or interface 500 that presents the latest updates on the physical, medical, and emotional status of the seniors.

In mobile application dashboard 316, as shown in FIG. 4, the mobile application 108 provides a quick glance of the physical, medical, and emotional status of the senior user 130. Instant notifications are sent to family members (e.g., on any deviations from the norm). These insights provide the family a sense of security with respect to the seniors living apart them. Buttons (or other user-selectable indicia) for improving the mood of the senior are present in the mobile application dashboard 316. A family member user 128 can click a user-selectable indicium in the form of an improve mood button 402 to alter the conversational contents with the senior user 130.

In mobile application newsfeed 318 as shown in FIG. 5, the mobile application 108 provides updates from family and friends, including updates from seniors accessing the voice applications 122 (e.g., voice user interfaces (VUIs) and voice capabilities or applications built using Alexa Skills Kit (ASK)) through a voice assistant application. These interactions facilitate social connections among family and friends and provide seniors a sense of attachment.

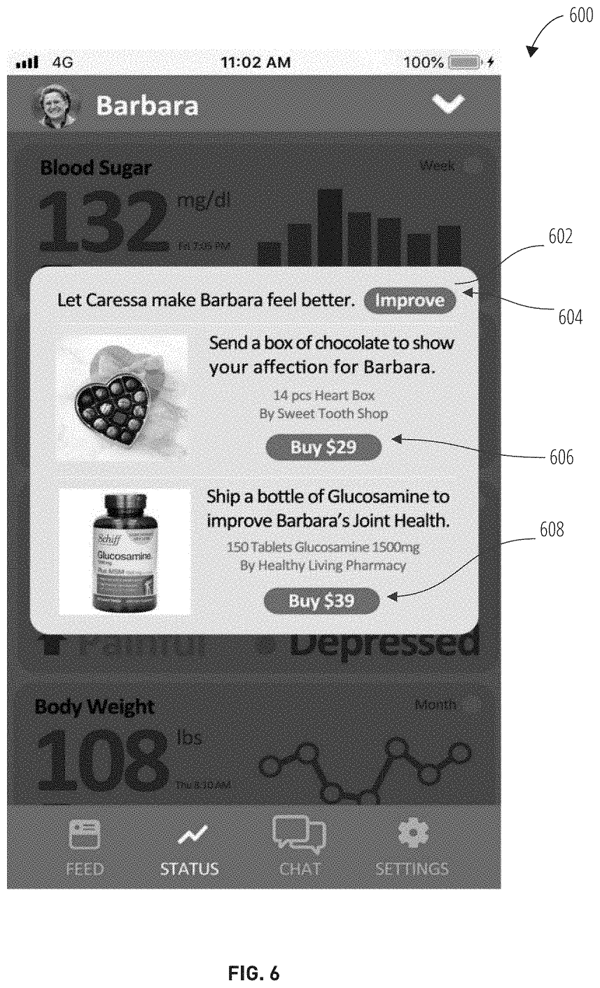

FIG. 6 is a user interface diagram showing a mobile application dashboard 316, according to an example embodiment, overlaid with a pop-up window 602 that includes a user-selectable indicium in the form of a mood improvement button 604. User selection of the mood improvement button 604 initiates a mood improvement response by the communications system 104. Specifically, the communication system 104 will, as described herein, adjust a content delivery flow to the senior user 130 in order to modify or adjust the mood of the senior user 130.

The pop-up window 602 also includes a purchase-initiation button 606, which is user-selectable to initiate a purchase flow for a particular product (e.g., a box of chocolates) that may be sent to the senior use. A further purchase-initiation button 608 is likewise user-selectable to initiate a purchase flow for a healthcare product (e.g., wellness tablets). Each of the products for which the purchase flows are initiated by selection of the button 606 and button 608 are specifically selected by the communications system 104 based on an assessed mood of the senior user. For example, where the senior user is assessed to be feeling depressed or “low”, products that are recognized to improve or lift a person's mood may be presented for purchase and delivery within the pop-up window 602 Accordingly, the pop-up window 602 presents two types of options to a user in order to improve the mood of the senior user 130, namely (1) to improve the mood by altering the content composition of the future conversations with or information feeds to the senior user, and (2) taking external actions (e.g., a purchase and delivery action) to improve the mood of the senior user.

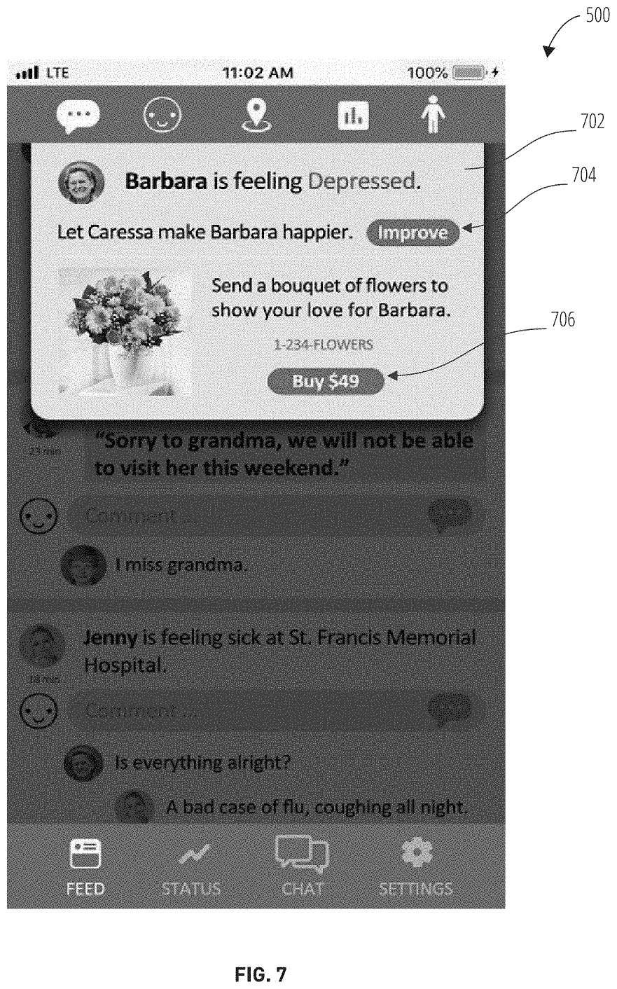

FIG. 7 is a user interface diagram showing a newsfeed tab or interface 500, according to an example embodiment, overlaid with a dropdown window 702 that includes a user-selectable indicium in the form of a mood improvement button 704. User selection of the mood improvement button 704 initiates a mood improvement response by the communications system 104. Specifically, the communications system 104 will, as described herein, adjust a content delivery flow to the senior user in order to modify or adjust the mood of the senior user 130.

The dropdown window 702 also includes a purchase initiation button 706, which is user-selectable to initiate a purchase flow for a particular product (e.g., flowers) that may be sent to the senior user 130. In this example, the flowers are selected by the communications system 104 based on an assessed mood of the senior user. For example, where the senior user 130 is assessed to be feeling depressed or “low”, flowers are selected to improve the mood of the senior.

The selection of a particular product or service for presentation to a user (e.g., in association with a purchase initiation button 706 or button 606) may furthermore be performed using an inventory of product/service advertisements maintained by the communications system 104 and paid for by advertisers. Accordingly, certain advertisers may subscribe certain advertisements (for selected products or services) to certain mood assessments, so that these advertisements are presented to a social network user related to the senior user 130 based on an assessment that the senior user is experiencing a particular mood.

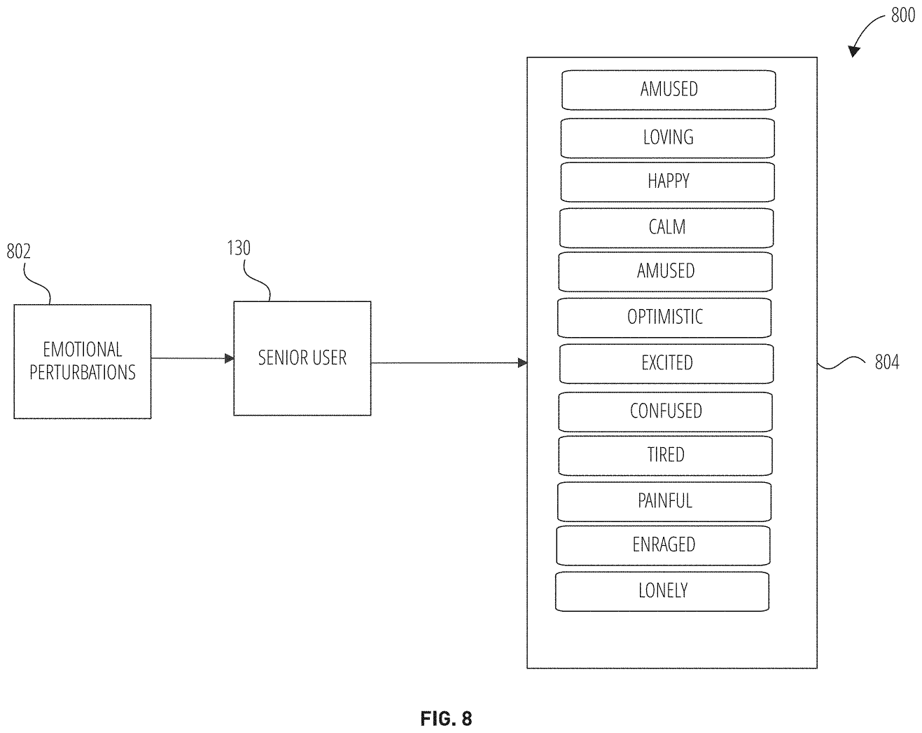

Turning now specifically the mood adjustment using content, the voice applications 122 carry out the conversation with the senior user 130, and also measure the effects of these conversations on one or more of moods 804 (see FIG. 8) after introducing each of multiple emotional events or influences (e.g., perturbations 802) to the senior user 130. The emotional perturbations 802 may be micro-conversations that are constructed by the respective AI conversation engines 120 from reporting news, weather, jokes, family updates, and other information. The communications system 104 further breaks down the content of each micro-conversations and analyze the relational impact. The emotional perturbations 802 are not limited to the conversational topics, as the communication communications system 104 also tracks other aspects of user profiles, such as services provided or environmental factors (e.g., room temperature, and current medical status).

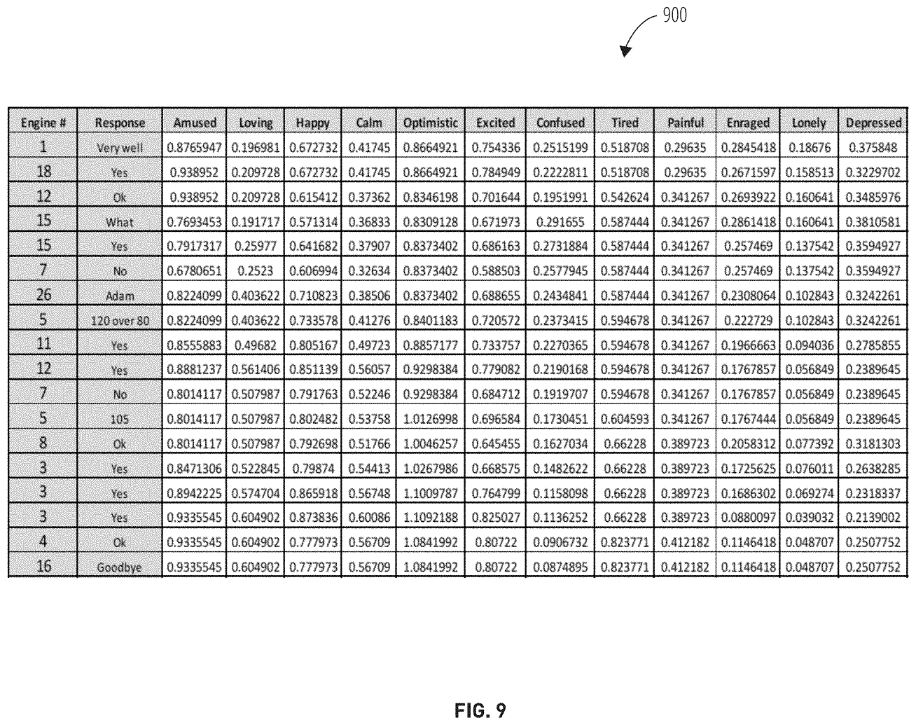

The moods 804 of a senior user 130 are measured and assessed in multiple ways, for example by asking the senior user 130, or by observing the interactions of the senior user 130 (e.g., as an extension or continuation of a particular conversation, the ending of a conversation prematurely, or interacting in confusion.) Moods 804 of a senior user 130 may further be measured directly from sensor data generated by sensors (e.g., Internet-of-Things (IoT) devices or smart home devices 134) within environments occupied by the senior user 130. The communications system 104 may also measure the response speed or response choices, and other interactional characteristics, and perform the emotional assessment 308 using an emotion matrix 900, such as that shown in FIG. 9.

Each of the emotional perturbations 802 may impact one or more emotions. As the communications system 104, and specifically the AI conversation engines 120, learn the cause and effects from each of the emotional perturbations 802, a knowledge base maintained by the AI conversation engines 120 are trained for each senior user 130. Given a desirable mood for the senior user 130 at a given moment, the communications system 104 reverses the process and introduces those emotional perturbations 802 to achieve the expected mood.

While example embodiments may only provide one option which is to improve mood in general, other example embodiments may seek to improve a specific mood such as loneliness, or a set of moods.

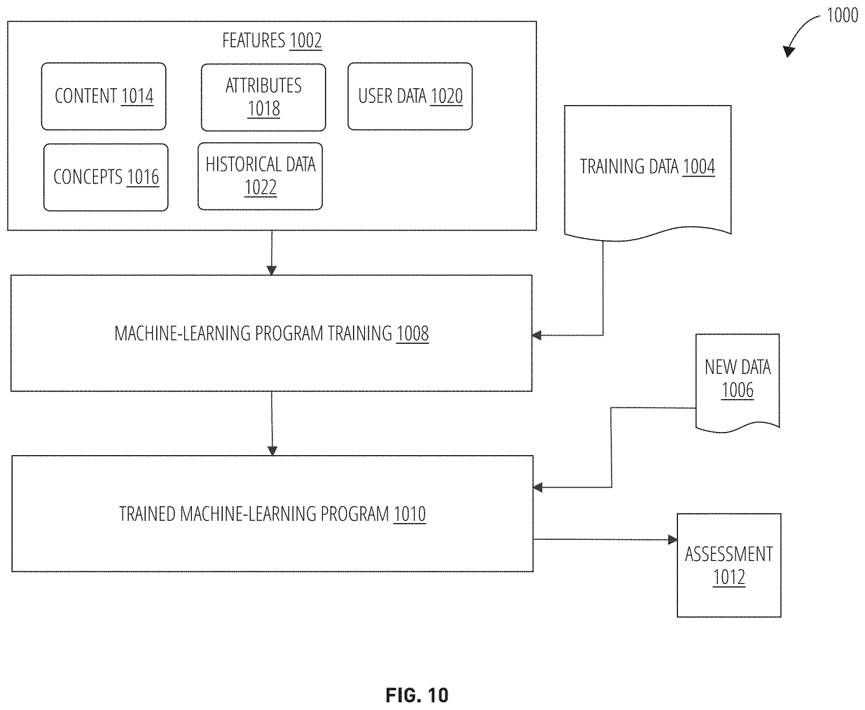

FIG. 10 illustrates training and use of a machine-learning program 1010, according to some example embodiments. In some example embodiments, machine-learning programs (MLPs), also referred to as machine-learning algorithms or tools, are used to perform operations associated with searches, such as job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 1004 in order to make data-driven predictions or decisions expressed as outputs or assessments 1012. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, example machine-learning algorithms provide an emotion affinity score (e.g., a number from 1 to 100) to qualify each emotional assessment 308 as a match for an emotional state data 322 (e.g., calculating an emotion affinity score on the emotion matrix 900). The machine-learning algorithms use the training data 1004 to find correlations among identified features 1002 that affect the outcome.

The machine-learning algorithms use features 1002 for analyzing the data to generate each emotional assessment 308. Each of the features 1002 is an individual measurable property of a phenomenon being observed or measured, as described above to measure the moods 804 of a senior. The concept of a feature is related to that of an explanatory variable used in statistical techniques such as linear regression. Choosing informative, discriminating, and independent features is important for the effective operation of the MLP in pattern recognition, classification, and regression. Features may be of different types, such as numeric features, strings, and graphs.

In one example embodiment, the features 1002 may be of different types and may include one or more of content 1014, concepts 1016, attributes 1018, historical data 1022 and/or user data 1020, merely for example.

The machine-learning algorithms use the training data 1004 to find correlations among the identified features 1002 that affect the outcome or assessment 1012. In some example embodiments, the training data 1004 includes labeled data, which is known data for one or more identified features 1002 and one or more outcomes, such as detecting communication patterns, detecting the meaning of the message, generating a summary of a message, detecting action items in messages detecting urgency in the message, detecting a relationship of the user to the sender, calculating score attributes, calculating message scores, etc.

With the training data 1004 and the identified features 1002, the machine-learning tool is trained at machine-learning program training 1008. The machine-learning tool appraises the value of the features 1002 as they correlate to the training data 1004. The result of the training is the trained machine-learning program 1010.

When the trained machine-learning program 1010 is used to perform an assessment, new data 1006 is provided as an input to the trained machine-learning program 1010, and the trained machine-learning program 1010 generates the assessment 1012 as output.

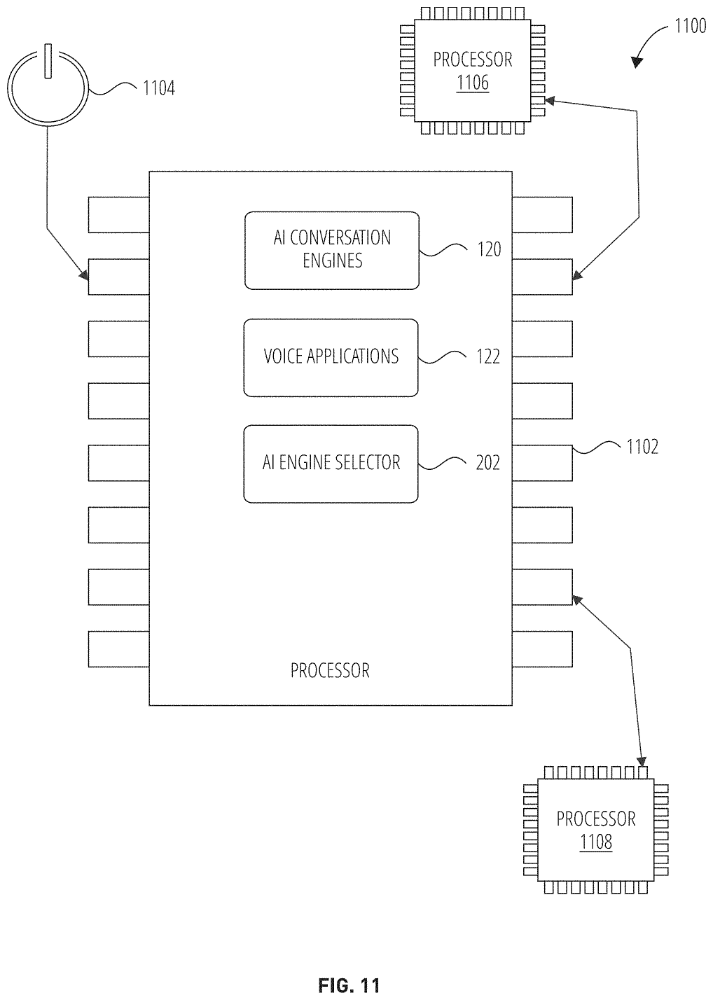

Turning now to FIG. 11, there is shown a diagrammatic representation of a processing environment 1100, which includes the processor 1106, the processor 1108, and a processor 1102 (e.g., a GPU, CPU or combination thereof).

The processor 1102 is shown to be coupled to a power source 1104, and to include (either permanently configured or temporarily instantiated) components, namely the AI conversation engines 120, the voice applications 122, and the AI engine selector 202. As illustrated, the processor 1102 is communicatively coupled to both the processor 1106 and processor 1108. The AI conversation engines 120 and/or the AI engine selector 202 may be viewed as comprising an AI component instantiated by the processor 1102.

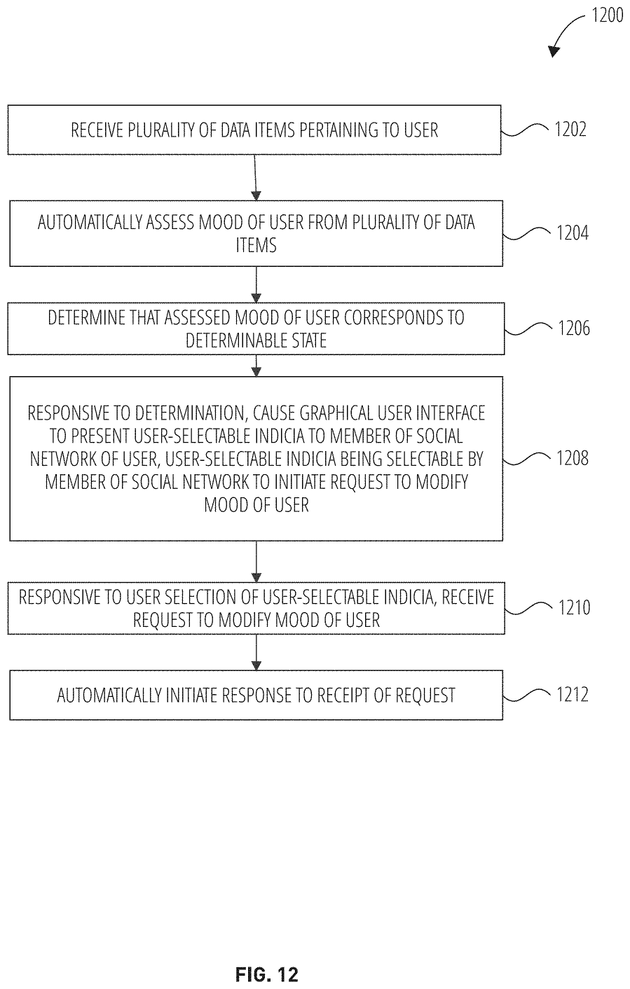

FIG. 12 is a flowchart illustrating a method 1200 to automatically adjust the mood of a senior user, according to some example embodiments.

In block 1202, method 1200 receives multiple data items pertaining to a user. The plurality of data items pertaining to the user may include any one or more of physical status data, emotional data, medical condition data, date and time data, home environment data and social network data.

In block 1204, method 1200 automatically assesses a mood of the user based on or using the data items received at block 1202. Specifically, as detailed above with respect to FIG. 8, the moods 804 of a senior user may be measured in multiple ways (e.g., features 1002 may be observed used to perform training 1008), and then new data 1006 may be assessed by the trained machine-learning program 1010 to output an assessment 1012.

In block 1206, method 1200 determines that the assessed mood (e.g., one of the moods 804) of the user corresponds to a determinable state (e.g., as represented in the emotional status data 322)

In block 1208, method 1200 responsive to the determination, causes a graphical user interface to present a user-selectable indicium to a member of a social network of the user, the user-selectable indicium being selectable by the member of the social network to initiate a request to modify the mood of the user.

In block 1210, method 1200 responsive to user selection of the user-selectable indicium, receives the request to modify the mood of the user.

In block 1212, method 1200 automatically performs an action in response to receipt of the request. In one embodiment, the action is a mood adjustment response that includes automatically adjusting the content delivery flow to the user using an artificial intelligence engine (e.g., the AI engine selector 202). As noted herein, the AI engine selector 202 automatically selects content from a plurality of conversation engines (e.g., the AI conversation engines 120) to create a conversation flow, as part of the content delivery flow, to the user via a voice interaction device (e.g., the voice client device 132). Further, the adjusting of the content delivery flow may include interleaving updates from the social network of the user into the content delivery flow.

The content delivery flow to the user is provided by a voice interaction device (e.g., the voice client device 132) and/or by a mobile application (e.g., executing on the voice client device 132).

The action performed in block 1212 may also be a mood improvement response that includes initiating a purchase flow for a product or service to be delivered to the user. The product or service is automatically selected by the communications system 104 based on the assessed mood of the user, and/or an association between an assessed mood and a category associated with a product or services advertisement maintained by the communications system 104 in an inventory of advertisements, paid for by advertisers.

Other mood adjustment responses may include initiation of online purchase, phone call (by the user), short statement or voicemoji to the senior user 130, for example.

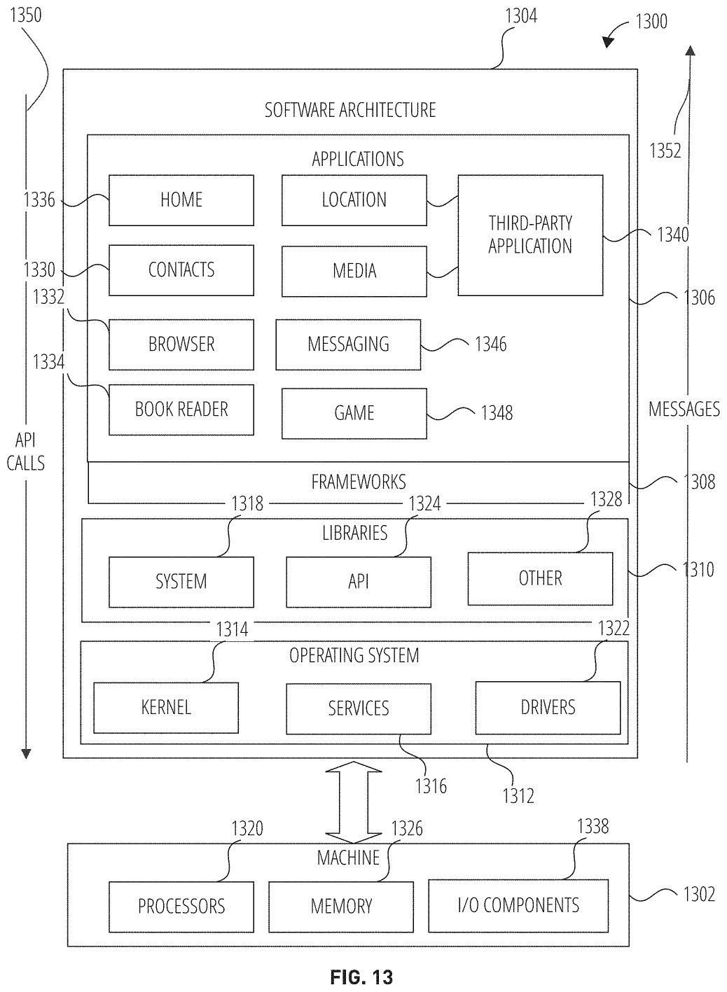

FIG. 13 is a block diagram 1300 illustrating a software architecture 1304, which can be installed on any one or more of the devices described herein. The software architecture 1304 is supported by hardware such as a machine 1302 that includes processors 1320, memory 1326, and I/O components 1338. In this example, the software architecture 1304 can be conceptualized as a stack of layers, where each layer provides a particular functionality. The software architecture 1304 includes layers such as an operating system 1312, libraries 1310, frameworks 1308, and applications 1306. Operationally, the applications 1306 invoke API calls 1350 through the software stack and receive messages 1352 in response to the API calls 1350.

The operating system 1312 manages hardware resources and provides common services. The operating system 1312 includes, for example, a kernel 1314, services 1316, and drivers 1322. The kernel 1314 acts as an abstraction layer between the hardware and the other software layers. For example, the kernel 1314 provides memory management, processor management (e.g., scheduling), component management, networking, and security settings, among other functionality. The services 1316 can provide other common services for the other software layers. The drivers 1322 are responsible for controlling or interfacing with the underlying hardware. For instance, the drivers 1322 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1310 provide a low-level common infrastructure used by the applications 1306. The libraries 1310 can include system libraries 1318 (e.g., C standard library) that provide functions such as memory allocation functions, string manipulation functions, mathematic functions, and the like. In addition, the libraries 1310 can include API libraries 1324 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1310 can also include a wide variety of other libraries 1328 to provide many other APIs to the applications 1306.

The frameworks 1308 provide a high-level common infrastructure that is used by the applications 1306. For example, the frameworks 1308 provide various graphical user interface (GUI) functions, high-level resource management, and high-level location services. The frameworks 1308 can provide a broad spectrum of other APIs that can be used by the applications 1306, some of which may be specific to a particular operating system or platform.

In an example embodiment, the applications 1306 may include a home application 1336, a contacts application 1330, a browser application 1332, a book reader application 1334, a location application 1342, a media application 1344, a messaging application 1346, a game application 1348, and a broad assortment of other applications such as a third-party application 1340. The e applications 1306 are programs that execute functions defined in the programs. Various programming languages can be employed to create one or more of the applications 1306, structured in a variety of manners, such as object-oriented programming languages (e.g., Objective-C, Java, or C++) or procedural programming languages (e.g., C or assembly language). In a specific example, the third-party application 1340 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1340 can invoke the API calls 1350 provided by the operating system 1312 to facilitate functionality described herein.

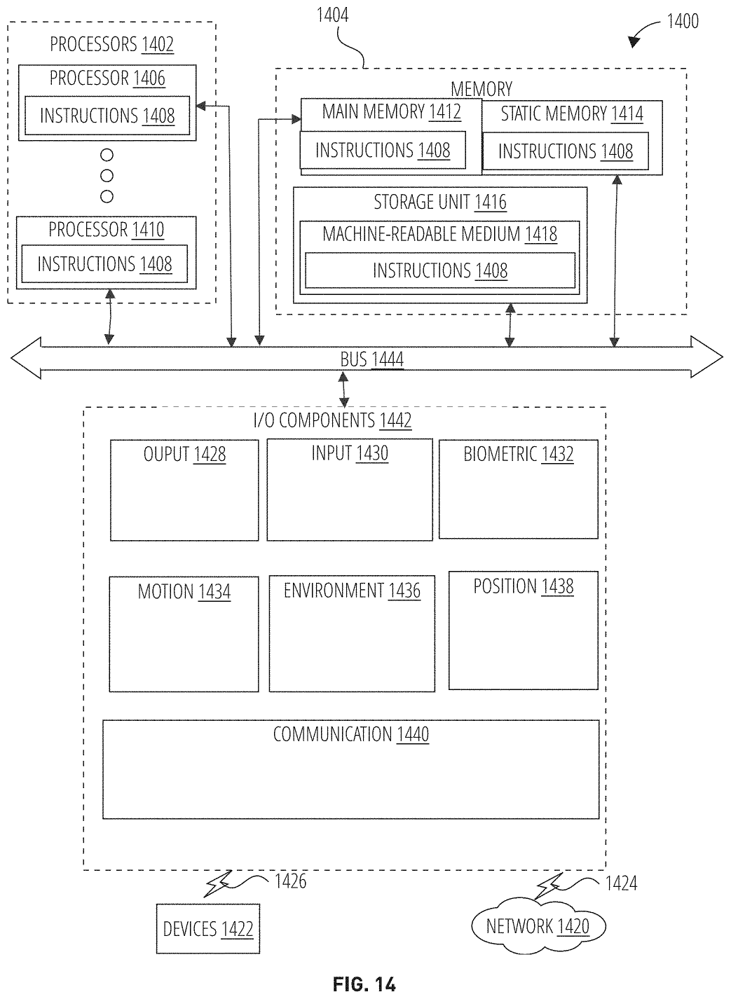

FIG. 14 is a diagrammatic representation of the machine 1400 within which instructions 1408 (e.g., software, a program, an application, an applet, an app, or other executable code) for causing the machine 1400 to perform any one or more of the methodologies discussed herein may be executed. For example, the instructions 1408 may cause the machine 1400 to execute any one or more of the methods described herein. The instructions 1408 transform the general, non-programmed machine 1400 into a particular machine 1400 programmed to carry out the described and illustrated functions in the manner described. The machine 1400 may operate as a standalone device or may be coupled (e.g., networked) to other machines. In a networked deployment, the machine 1400 may operate in the capacity of a server machine or a client machine in a server-client network environment, or as a peer machine in a peer-to-peer (or distributed) network environment. The machine 1400 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1408, sequentially or otherwise, that specify actions to be taken by the machine 1400. Further, while only a single machine 1400 is illustrated, the term “machine” shall also be taken to include a collection of machines that individually or jointly execute the instructions 1408 to perform any one or more of the methodologies discussed herein.

The machine 1400 may include processors 1402, memory 1404, and I/O components 1442, which may be configured to communicate with each other via a bus 1444, in an example embodiment, the processors 1402 (e.g., a Central Processing Unit (CPU), a Reduced Instruction Set Computing (RISC) processor, a Complex Instruction Set Computing (CISC) processor, a Graphics Processing Unit (GPU), a Digital Signal processor (DSP), an ASIC, a Radio-Frequency Integrated Circuit (RFIC), another processor, or any suitable combination thereof) may include, for example, a processor 1406 and a processor 1410 that execute the instructions 1408. The term “processor” is intended to include multi-core processors that may comprise two or more independent processors (sometimes referred to as “cores”) that may execute instructions contemporaneously. Although FIG. 14 shows multiple processors 1402, the machine 1400 may include a single processor with a single core, a single processor with multiple cores (e.g., a multi-core processor), multiple processors with a single core, multiple processors with multiples cores, or any combination thereof.

The memory 1404 includes a main memory 1412, a static memory 1414, and a storage unit 1416, both accessible to the processors 1402 via the bus 1444. The main memory 1404, the static memory 1414, and storage unit 1416 store the instructions 1408 embodying any one or more of the methodologies or functions described herein. The instructions 1408 may also reside, completely or partially, within the main memory 1412, within the static memory 1414, within machine-readable medium 1418 (e.g., non-transitory storage) within the storage unit 1416, within at least one of the processors 1402 (e.g., within the processor's cache memory), or any suitable combination thereof, during execution thereof by the machine 1400.

The I/O components 1442 may include a wide variety of components to receive input, provide output, produce output, transmit information, exchange information, capture measurements, and so on. The specific I/O components 1442 that are included in a particular machine will depend on the type of machine. For example, portable machines such as mobile phones may include a touch input device or other such input mechanisms, while a headless server machine will likely not include such a touch input device. It will be appreciated that the I/O components 1442 may include many other components that are not shown in FIG. 14. In various example embodiments, the I/O components 1442 may include output components 1428 and input components 1430. The output components 1428 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1430 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1442 may include biometric components 1432, motion components 1434, environmental components 1436, or position components 1438, among a wide array of other components. For example, the biometric components 1432 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1434 include acceleration sensor components (e.g., accelerometer), gravitation sensor components, rotation sensor components (e.g., gyroscope), and so forth. The environmental components 1436 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1438 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1442 further include communication components 1440 operable to couple the machine 1400 to a network 1420 or devices 1422 via a coupling 1424 and a coupling 1426, respectively. For example, the communication components 1440 may include a network interface component or another suitable device to interface with the network 1420. In further examples, the communication components 1440 may include wired communication components, wireless communication components, cellular communication components, Near Field Communication (NFC) components, Bluetooth® components Bluetooth® Low Energy), Wi-Fi® components, and other communication components to provide communication via other modalities. The devices 1422 may be another machine or any of a wide variety of peripheral devices (e.g., a peripheral device coupled via a USB).

Moreover, the communication components 1440 may detect identifiers or include components operable to detect identifiers. For example, the communication components 1440 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1440, such as location via Internet Protocol (IP) geolocation, location via Wi-Fi® signal triangulation, location via detecting an NFC beacon signal that may indicate a particular location, and so forth.

The various memories (e.g., memory 1404, main memory 1412, static memory 1414, and/or memory of the processors 1402) and/or storage unit 1416 may store one or more sets of instructions and data structures (e.g., software) embodying or used by any one or more of the methodologies or functions described herein. These instructions (e.g., the instructions 1408), when executed by processors 1402, cause various operations to implement the disclosed embodiments.

The instructions 1408 may be transmitted or received over the network 1420, using a transmission medium, via a network interface device (e.g., a network interface component included in the communication components 1440) and using any one of a number of well-known transfer protocols (e.g., hypertext transfer protocol (HTTP)). Similarly, the instructions 1408 may be transmitted or received using a transmission medium via the coupling 1426 (e.g., a peer-to-peer coupling) to the devices 1422.

What is claimed is:

1. A method comprising:
receiving a plurality of data items pertaining to a user;
automatically assessing a mood of the user from the plurality of data items;
determining that the mood of the user corresponds to a determinable state;
responsive to the determination, causing a graphical user interface to present a user-selectable indicium to a member of a social network of the user, the user-selectable indicium being selectable by the member of the social network to initiate a request to modify the mood of the user;
responsive to user selection of the user-selectable indicium, receiving the request to modify the mood of the user; and
automatically initiating a mood improvement response using a server, in response to the receipt of the request.

2. The method of claim 1, wherein the plurality of data items pertaining to the user include any one or more of physical status data, emotional data, medical condition data, date and time data, home environment data and social network data.

3. The method of claim 1, wherein the mood improvement response comprises adjusting a content delivery flow to the user.

4. The method of claim 3, wherein the adjusting of the content delivery flow to the user includes using an artificial intelligence engine automatically to select content from a plurality of conversation engines to create a conversation flow, as part of the content delivery flow, to the user via a voice interaction device.

5. The method of claim 4, wherein the content delivery flow to the user is provided by at least one of a voice interaction device and a mobile application.

6. The method of claim 5, wherein the mobile application includes a news feed interface configured to provide updates from the social network of the user.

7. The method of claim 3, wherein the adjusting of the content delivery flow includes interleaving updates from the social network of the user into the content delivery flow.

8. The method of claim 1, wherein the mood improvement response includes initiating a purchase flow for a product or service to be delivered to the user.

9. The method of claim 8, wherein the product or service is automatically selected by the server based on the assessed mood of the user.

10. The method of claim 8, wherein the mood improvement response includes automatically initiating a communication to the user.

11. The method of claim 9, wherein the communication is a voice communication session or a text-based message.

12. A system to automatically improve a mood of a user, the system comprising:
a data interface to receive a plurality of data types indicative of the mood of the user; and
an artificial intelligence component automatically to:
assess the mood of the user;
responsive to detecting that the mood of the user is in a determinable state, causing a graphical user interface to present a user-selectable indicium to a member of a social network on the user, the user-selectable indicium being selectable by the member of the social network to initiate a request to improve the mood of the user, wherein:
the data interface is to receive the request to improve the mood of the user;
the artificial intelligence component is to automatically adjust content delivery to the user in order to modify the mood of the user.

13. A computing apparatus, the computing apparatus comprising:
a processor; and
a memory storing instructions that; when executed by the processor, configure the apparatus to:
receive a plurality of data items pertaining to a user;
automatically assess a mood of the user from the plurality of data items;
determine that the assessed mood of the user corresponds to a determinable state;
responsive to the determination, cause a graphical user interface to present a user-selectable indicium to a member of a social network of the user; the user-selectable indicium being selectable by the member of the social network to initiate a request to modify the mood of the user;
responsive to user selection of the user-selectable indicium, receive the request to modify the mood of the user; and
automatically adjust a content delivery flow to the user in response to receipt of the request.

14. The computing apparatus of claim 13, wherein the plurality of data items pertaining to the user include any one or more of physical status data, emotional data, medical condition data, date and time data, home environment data and social network data.

15. The computing apparatus of claim 13, wherein the adjusting of the content delivery flow to the user includes using an artificial intelligence engine automatically to select content from a plurality of conversation engines to create a conversation flow, as part of the content delivery flow, to the user via a voice interaction device.

16. The computing apparatus of claim 13, wherein the content delivery flow to the user is provided by a voice interaction device and by a mobile application.

17. The computing apparatus of claim 16, wherein the mobile application includes a news feed interface configured to provide updates from the social network of the user.

18. The computing apparatus of claim 13, wherein the adjusting of the content delivery flow includes interleaving updates from the social network of the user into the content delivery flow.

19. A non-transitory computer-readable storage medium, the computer-readable storage medium including instructions that when executed by a computer, cause the computer to:
receive a plurality of data items pertaining to a user;
automatically assess a mood of the user from the plurality of data items;
determine that the assessed mood of the user corresponds to a determinable state;
responsive to the determination, cause a graphical user interface to present a user-selectable indicium to a member of a social network of the user, the user-selectable indicium being selectable by the member of the social network to initiate a request to modify the mood of the user;
responsive to user selection of the user-selectable indicium, receive the request to modify the mood of the user; and
automatically initiate a mood improvement response use a server, in response to the receipt of the request.
